(19) United States
(12) Patent Application Publication
(10) Pub. No.: US 2019/0356939 A1
(43) Pub. Date: Nov. 21, 2019

(54) Systems and Methods for Displaying Synchronized Additional Content on Qualifying Secondary Devices

(71) Applicant: Calvin Kuo, Torrance, CA (US)

(72) Inventor: Calvin Kuo, Torrance, CA (US)

(21) Appl. No.: 16/258,052

(22) Filed: Jan. 25, 2019

Related U.S. Application Data
(60) Provisional application No. 62/672,057, filed on May 16, 2018.

(51) Int. Cl. H04N 21/41; G06F 3/14; H04N 21/4545; H04N 21/475; H04N 21/443

(52) U.S. Cl. CPC H04N 21/4122; G06F 3/1438; H04N 21/4438; H04N 21/4758; H04N 21/45457

(57) ABSTRACT

A method of displaying secondary content on secondary screen devices, comprising the steps: providing a primary screen content that is displayed on a theater screen; providing secondary screen devices that contain or have access to secondary screen content that is played in synchronicity with the primary screen content. The secondary screen content may include content that is available to all at a specific time point in the movie and content that is only available to users that have earned the right to watch the content. The earned content may be content that is integral and contextual to the primary screen content. Preferably, the earned content may be additional information, plot, or anagnorisis content that is not available in the primary screen content.

### CROSS-REFERENCE TO RELATED APPLICATION

This application claims the benefit of U.S. Provisional Application No. 62/672,057, filed on May 16, 2018, by Inventor Calvin Kuo, entitled “Systems and methods for displaying movie contents on a secondary screen device”, the contents of which are incorporated herein by reference as though set forth in their entirety.

### FIELD OF THE DISCLOSURE

The present disclosure relates generally to systems and methods of enhancing a movie experience by displaying certain movie content on a secondary screen device while the main movie content is being displayed on a primary display screen.

### BACKGROUND

Presently, the experience of watching a movie is generally an impersonal and passive experience. All the viewers in the audience watch the same content, and thus have the same baseline for understanding and interpreting the movie. This leads to a less unique experience for each viewer relative to other viewers in the audience. Furthermore, there is little opportunity for a viewer to interact with the contents of a movie in a way that relevantly enhances the viewer's understanding of the movie.

Currently, movie theaters and other types of audio-visual work venues, do not have responsive media players or computer systems that are able to receive and send messages, data, and input to and from secondary screen user devices. Current movie theater systems are also deficient because the movies shown have preset scenes and scene sequences, so altering the movie, such as with an alternate ending, based on interactions with the secondary screen user devices, is not feasible.

Secondary content systems prior to the systems of the present disclosure primarily offer content that may detract from the immersive movie experience, such as merchandising advertisements, trivia, or polls. The secondary content of current systems is not an interactive movie obstacle that results in additional earned content that aids in the understanding or appreciation of aspects of the movie. Systems prior to the system of the present disclosure do not provide a gamification aspect that result in relevant, contextual movie content being earned.

Systems prior to the system of the present disclosure offer secondary content without consideration of crossmodal attention interference relative to the main movie content concurrently displayed on the main movie screen. This can lead to the viewer regarding the secondary content as distracting rather than complimentary to the main movie content.

Thus, what is needed is a secondary content system that provides (1) an interactive theater system and setting that (2) allows a user to engage in secondary content that is minimally distracting to the main movie content through a secondary screen device that needs not be in wireless communication with a theater media player, (3) wherein the engagement with the secondary content allows the user to unlock or earn relevant contextual content, including (4) possible alternate endings that do not modify the actual main movie content, and/or content that enhances the understanding and appreciation of the movie.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

The present disclosure provides systems and methods for utilizing a secondary screen device (“SSD”), such as a smartphone, that provides a more personalized movie/theatrical experience.

In certain embodiments, the contents of the movie/film may be segregated into main content, which is displayed on the primary display screen for all viewers, and SSD content, which is displayed only on the SSD.

In one embodiment, access to certain SSD content may be dependent on how a viewer interacted with previously displayed SSD content. Because the earned content may be displayed only to certain viewers, each viewer in the theater may have a different experience and even a different interpretation of the movie.

In some embodiments, some of the SSD content may comprise interactive content that involves or relates to events or characters in the movie, such as an interactive puzzle that the protagonist is also attempting to solve, or commands that can be issued to characters in the movie while they are off screen. Importantly, this content may be structured in a way that minimizes distraction for the user/viewer from the main content of the movie being presented on the main screen.

In some embodiments the SSD content may be content of a more restrictive MPAA rating than the main content, thus providing a movie experience that may appeal to more mature tastes without alienating the broader audience that is watching the primary movie content (i.e. the main content) with the user.

In some embodiments the restricted, or earned, SSD content may comprise plot twists, such as an anagnorisis of a character, event, location, or action in the movie. In this context, anagnorisis means any discovery that produces a change from ignorance to knowledge. For example, in a detective movie, a restricted SSD content may be a video clip that shows the antagonist, such as a serial killer, unbeknownst to the detective, is actually the detective's long-lost brother. Viewers that earn access to this SSD content may have a different appreciation of the serial killer's motives and interactions with the detective than a viewer without access to this SSD content. Prior to the system of the present disclosure, the earned content is entirely limited to an ad, unnecessary bonus material, a game, puzzle, or other non-contextual/non-plot related content that does not further the viewer's understanding of the movie.

By linking SSD content to a contextual understanding of a movie, and restricting access to certain SSD content (i.e., the earned content) based on a viewer's interaction with previous SSD content, the system of the present disclosure may introduce elements of gamification into a movie watching experience (overcoming obstacles to get access to all of the earned content) without suffering from an over-justification effect.

One embodiment of the system of the present disclosure may be a method to use SSD to introduce aspects of gamification, personalization, and active consumption to a movie watching experience without affecting the movie contents shown on the main screen.

One embodiment may be a method of displaying a plurality of secondary content on one or more secondary screen devices simultaneously with a main content being displayed on a primary device screen, wherein the internal clock of the secondary screen device is synchronized to the play time of the main content, the method comprising the steps: wherein the plurality of secondary content comprises at least one first secondary content and at least one earned secondary content; incrementing the secondary screen device clock time, and fetching from a content database any first secondary content that may exist for the specific clock time; displaying the fetched first secondary content, if any, on the secondary screen device; for each fetched first secondary content, recognizing by the system that the user has viewed or interacted with the fetched first secondary content and recording credit to the user for the viewing/interaction; determining by the system that the user may be entitled to view/obtain one or more earned secondary content; fetching the one or more earned secondary content; and displaying the one or more earned secondary content on the second screen device. In some embodiments, the first secondary content is an interactive content that contains no audio or closed caption dialog. Preferably the interactive content is selected from the group of interactive content consisting of: (1) an interactive visuospatial puzzle that is mentioned or attempted by characters in the movie; (2) a maneuverable or changeable point of view of a location, the location containing a clue that, if discovered by the viewer, will enhance the viewer's comprehension of the movie; (3) a preset list of selections, wherein each selection may represent a simulated communication to characters or objects in the movie, wherein upon the display of the first secondary content, for the next thirty seconds the main content contains at least one block of N or greater seconds with no audible and/or comprehendible dialog or speech and N may=floor (1.5×) where x is the number of selections in the preset list; and (4) a preset list of selections, wherein each selection represents a simulated action taking place in the movie, wherein upon the display of the first secondary content, for the next thirty seconds the main content contains at least one block of N or greater seconds with no audible and/or comprehendible dialog or speech and where N may=floor(1.5×) where x is the number of selections in the preset list. In some embodiments, the earned secondary content contains no auditory dialog or speech and may comprise one or more of the following: (1) content that provides the viewer anagnorisis regarding a character, event, location, or action in the movie; or (2) content that employs a priming technique on the viewer to help the viewer obtain anagnorisis of a character, event, location, or action in the movie.

In accordance with the embodiments disclosed herein, the present disclosure may be a method of displaying movie contents on a secondary screen device, comprising the steps: Synchronizing the secondary screen device to the current play time of the main content being displayed on the primary display screen; Fetching from a content database any first secondary content that may exist for the current play time; Displaying fetched first secondary content, if any, on the secondary screen device; For each instance of fetched first secondary content, responsive to conditions that may have been met for the instance of fetched first secondary content, returning a value to the instance of fetched first secondary content's credential field in the user credential library (“UCL”); Fetching from a content database any earned secondary content that may exist for the current play time; For each instance of fetched earned secondary content, if any, displaying it on the secondary screen device only if the UCL credential values match the instance of fetched earned secondary content's credential requirements; and For each instance of fetched earned secondary content, responsive to conditions that may have been met for the instance of fetched earned secondary content, returning a value to the instance of fetched earned secondary content's credential field in the user credential library. The first secondary content or the earned secondary content or both may comprise a puzzle from the primary screen content (i.e. the main movie content that all viewers see) with which the viewer may interact. Alternatively, the first secondary content or the earned secondary content or both may comprise simulated instructions or questions issued to characters in the movie. In one embodiment the first secondary content or the earned secondary content or both may comprise a scene from the primary screen content that the viewer may interact with to change the viewing angle or point of view. In another embodiment the first secondary content or the earned secondary content or both may comprise of content of a more restrictive MPAA-rating than the primary screen content. In another embodiment, the earned secondary content may comprise a plot twist that is not provided in the primary screen content. In another embodiment the earned secondary content may comprise an anagnorisis that is not provided in the primary screen content. In another embodiment the first secondary content or the earned secondary content or both may be displayed on the secondary screen device at a time-offset of the current play time.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a process diagram illustrating one embodiment of the system of the present disclosure providing earned secondary content to a secondary screen device.

FIG. 2 is a flow diagram of one embodiment of the method for providing earned secondary content.

FIG. 3 is an illustration of one embodiment of the system showing the secondary screen device displaying first secondary content and earned secondary content and returning values to a user credential library for a given play time.

FIG. 4 is an illustration of one embodiment of the system showing the secondary screen device displaying first secondary content and returning a value to a user credential library based on which first secondary content's condition is met by the viewer.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are signify both in relation to the other endpoint, and independently of the other endpoint.

“Optional” or “optionally” means that the subsequently described event or circumstance may or may not occur, and that the description includes instances where the event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

For the purpose of present disclosure, various terms used in the art are defined as follows:

The term “movie” is used for convenience, and shall include any pre-recorded/pre-produced, time-based visual media presentation including, but not limited to, films, feature length films, short films, animated films, television shows, and internet shows.

The term “primary display screen” or “PDS” means the main display that displays the main/primary content of a movie to all the viewers in an audience. A PDS may include but is not limited to: a movie projection screen, an LED display/screen, a television screen, an LCD display/screen, and/or a computer monitor. The PDS displays the primary screen content.

The term “secondary screen device” or “SSD” means a personal mobile/portable device with a display screen or projector. The SSD is typically a smartphone with an LED or LCD, but may be a tablet, laptop, or virtual reality/augmented reality glasses. The secondary screen devices display the first secondary content and the earned secondary content.

The term “movie content” or “work content” shall mean all the visual, audio, and tactile (such as smartphone vibration) content the filmmakers or content producers create for a movie watching audience. Movie content for purposes of the present disclosure consists of primary screen content (also called main content), first secondary content, and earned secondary content.

The term “primary screen content” shall mean the portion of a movie's content that is shown on the PDS to all viewers in an audience. Primary screen content is traditionally audio/video content, but in some instances, it could be interactive video content like a “choose-your-own-adventure”story shown on a “smart TV” or a computer. A smart TV is a TV and processing system combination, e.g., a TV with a built-in processing system, or a TV to which a processing system is attached. Some examples of commercially available TV-attachable processing systems include but are not limited to APPLE TV®, AMAZON FIRE®, GOOGLE CHROMECAST®, and ROKU®.

“First secondary content” and “earned secondary content” are terms that refer to portions of a movie's content that is shown on the SSDs. First secondary content and earned secondary content are collectively referred to as “SSD content.” An instance of SSD content may be an instance of first secondary content, or an instance of earned secondary content. In some cases, an instance of SSD content may duplicate portions of the main content, as in the example of an instance of SSD content being a video clip of a movie scene that was previously displayed on the PDS. SSD content may comprise various combination of audio, visual, and/or tactile (such as smartphone vibration) content, including interactive content. Each instance of SSD content may also contain one or more conditions that may be met based on how a viewer interacts with the instance of SSD content, such as an instance of SSD content being an interactive puzzle that a viewer needs to solve within a specific time limit (such as thirty seconds). Each instance of SSD content may also comprise a display time length, which will terminate the display of the instance of SSD content once its display time length (time limit) has elapsed. In some cases, an instance of SSD content's display time length may be set to a null value representative of infinite time, as in the case where an instance of SSD content may be accessed by the viewer at any time for however long the viewer wishes.

The term “user credential library” or “UCL” for purposes of this disclosure means a set of first secondary content credential values and earned secondary content credential values. Each instance of SSD content preferably has a corresponding credential field in the UCL, the credential field containing a credential value that may be initialized to some default value. An instance of SSD content may return a value to its corresponding credential field based on what conditions, if any, a viewer meets when the instance of SSD content is displayed. A returned value from an instance of SSD content may replace the previously existing credential value in the instance of SSD content's corresponding credential field, or it may modify the previously existing credential value in some other way, such as adding to it. Furthermore, an instance of SSD content with no conditions (as may be the case in an instance of SSD content that is a non-interactive video clip), an instance of SSD content where the viewer fails to meet any existing conditions, or an instance of SSD content that is not displayed (as in the case of an instance of earned secondary content that the viewer does not have the proper UCL credential values to display) may be designed to return no value to its corresponding credential field, thus leaving its previously existing credential value unaltered.

Typically, the first secondary content is responsive to the play time (i.e. temporal location) of the primary screen content being displayed on the PDS and is displayed in synchronicity on the SSD.

Typically, the earned secondary content may be displayed on the SSD and may be responsive to both the play time of the primary screen content and to the UCL credential values. Preferably, each instance of earned secondary content will have “credential requirements” representing required credential values in certain credential fields in the UCL. For an instance of earned secondary content that may exist for a given play time of the primary screen content, the relevant UCL credential values must also match the credential requirements of the instance of earned secondary content in order for the instance of earned secondary content to be displayed on the relevant SSD. In this manner, the instance of earned secondary content is only displayed if the viewer has met certain conditions related to previously displayed first secondary content and/or earned secondary content, thus having the proper relevant UCL credential values to match the credential requirements of the instance of earned secondary content.

The term “secondary content database” for purposes of this disclosure refers to the database that contains all the SSD content indexed to play times (or temporal locations) of the primary screen content for a particular movie. The content database may take the form of an array, a list, or some other data structure. For example, in some embodiments a content database may be in an array form where the array index is calculated by some hash function of the play times of the primary screen content, and each array element may represent all the SSD content for a given play time of the primary screen content. In some embodiments, an array element may be another array (i.e. a nested array) in which the nested array index is a sequential order of the SSD content that exists for a given play time. In some embodiments, each instance of SSD content may be associated with a separate array element denoting whether that instance of SSD content has been viewed or not. This could be handled, for example, by a multidimensional array structure in which an extra row or column is created to track whether each instance of SSD content has been viewed on a particular SSD.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

In various implementations, there may be provided a system and method for providing contextual earned secondary content to a user on their personal electronic device related to a movie that the user is watching.

In some embodiments, the secondary content database and/or the UCL may reside on the SSDs, or they may reside on a remote server accessed wirelessly by the SSDs.

In some embodiments, for a given play time, the SSD checks for and displays each instance of first secondary content before then checking for and displaying (subject to the UCL credential values) each instance of earned secondary content. In other embodiments, for a given play time, the SSD checks for and queues up all instances of first secondary content and earned secondary content in a display queue before displaying them (subject to the UCL credential values) in order.

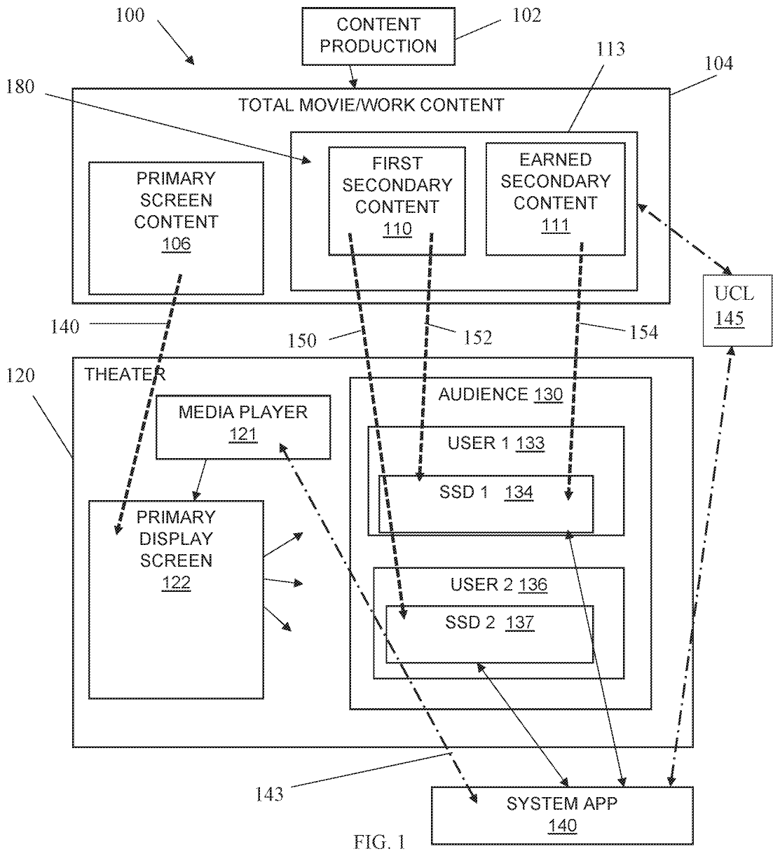

FIG. 1 is a process diagram illustrating the system of the present disclosure providing earned movie content to a secondary screen device. As shown in FIG. 1, the system 100 may comprise producing content 102, a total movie content 104, a theater 120, and a system app 140. The total movie content 104 may comprise primary screen content 106, first secondary content 110, and earned secondary content 111. The first secondary content 110 and earned secondary content 111 may be referred to as SSD content 113. The primary screen content 106 of the movie 104 is played 140 on the primary display screen 122. The audience may comprise multiple people or users, represented by user 1 133 and user 2 136. Each user preferably has a second screen device, such as SSD 134, 137.

The theater 120 is one embodiment of a setting for an audience 130 to watch the primary screen content 106 on primary display screen 122.

The SSD content 113 may be stored in secondary content database 180, which may be loaded onto each SSD 134, 137, or may be stored in the cloud and accessed wirelessly 150, 152, 154.

FIG. 1 shows one embodiment of a system that provides an enhanced movie experience to an audience 130. The scriptwriter, director, producers, and other content producers of a movie create 102 all the movie contents 104 that make up a movie. The movie contents 104 may be divided into primary screen content 106, first secondary content 110, and earned secondary contents 111. The primary screen content 106 may be stored in a visual media storage of a media player, such as a film reel, hard drive, or a Blu-ray® disc. The media player 121 plays the movie on the primary display screen 122 to the audience 130. The system 100 may comprise a system app 140, which the users 1 and 2 133, 136 may download onto SSD 1 and 2 134, 137. The app 140 may comprise, or otherwise allow access to secondary content database 180. While watching the primary screen content 106 on PDS 122, the users 1 and 2 133, 136 use, simultaneously, the app 140 on their devices 134, 137.

FIG. 1 shows that the system may further comprise a user credential library 145, which in various embodiments, may reside on the SSDs, or they may reside on a remote server accessed wirelessly by the SSDs.

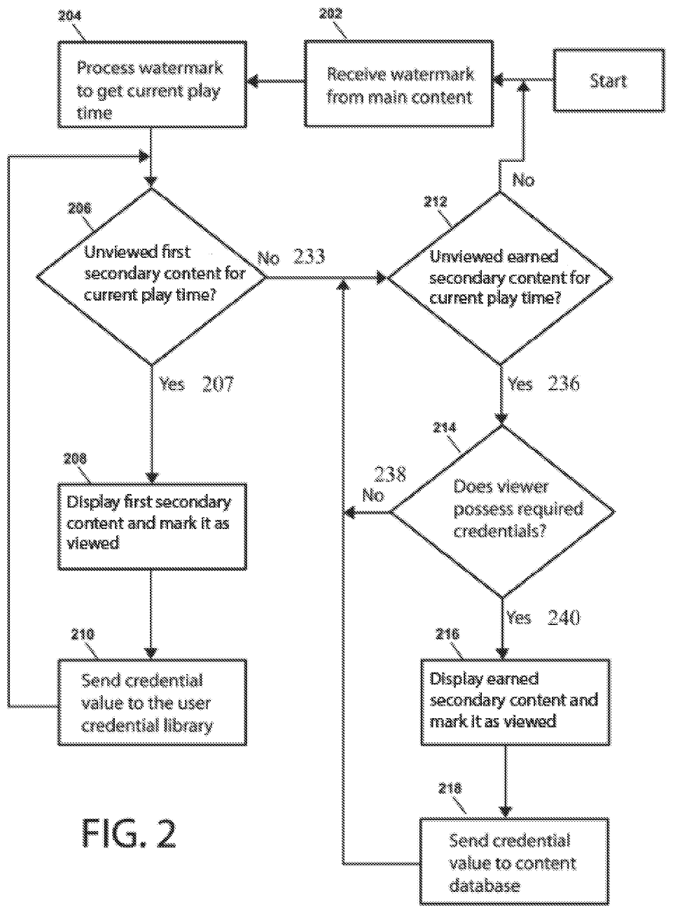

FIG. 2 is a flow diagram of one embodiment of the method for providing earned secondary content. As shown in FIG. 2, the SSD may receive a digital watermark from the primary screen content 202, wherein the digital watermark tracks the temporal location of the primary screen content being displayed on the PDS. One example of a digital watermark is high frequency audio samples embedded in the primary screen content and received by a microphone on the SSD. Another example would be a wireless signal, packet, or data stream sent by the PDS media player to the system app of the SSD. The digital watermark may be processed (for example by a hash function) to determine the current play time of the primary screen content 204. The system app on the SSD checks against the secondary content database to see if there are any unviewed first secondary content 206 for the current play time. If there is unviewed first secondary content 207 for the current play time, then an instance of unviewed first secondary content is displayed on the SSD (in some embodiments it may also be displayed at some time offset from the current play time) and the instance of unviewed first secondary content is marked as viewed 208. Depending on what conditions, if any, are met for the displayed instance of first secondary content, the system returns a value to the displayed instance of first secondary content's credential field in the UCL 210 and checks for any additional unviewed first secondary content 206 for the current play time. If there are no more unviewed first secondary contents for the current play time 233, then the system checks the secondary content database for any unviewed earned secondary content 212 for the current play time. If an instance of unviewed earned secondary content exists for the current play time 236, the system checks the UCL to see if the viewer possesses the correct credential values for the instance of unviewed earned secondary content 214. If no 238, then the system marks the instance of unviewed earned secondary content as viewed without displaying it, then checks the content database for any further unviewed earned secondary content 212 for the current play time. If an instance of unviewed earned secondary content exists at current play time and the UCL check 214 indicates the viewer possesses the necessary credential values 240 for the instance of unviewed earned secondary content, then the system allows the SSD to access and display (contemporaneously or at a time offset from the current play time) the instance of unviewed earned secondary content and mark it as viewed 216. Depending on what conditions, if any, are met for the displayed instance of earned secondary content, the system returns a value to the displayed instance of earned secondary content's credential field in the UCL 218 and then, again, checks for any additional unviewed earned secondary content 212 for the current play time. If there are no unviewed earned secondary content for current play time 212, then the system synchs with the primary screen content by receiving a digital watermark from primary screen content 202 to get the updated current play time.

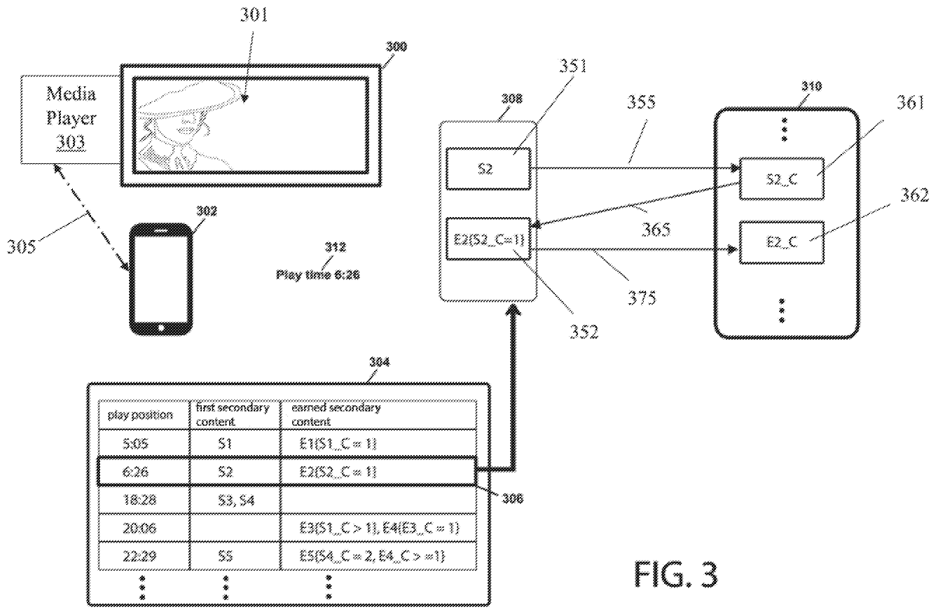

FIG. 3 is an illustration of one embodiment of the system showing the secondary screen device displaying first secondary content and earned secondary content and returning values to a user credential library for a given play time. The primary display screen 300 plays/displays the primary screen content 301 for the audience to watch. In a preferred embodiment, each viewer will have a secondary screen device 302 that receives a digital watermark from the PDS 300 and may process the signal to calculate the current play time 312. Secondary content database 304, which may reside on the SSD 302, the cloud, or a dedicated server, is accessed by the system, and the SSD content 351, 352 for the current play time 306 are precached for display in display queue 308, which may take the form of an array or other similar data structure. First secondary content S2 351 is displayed first (on SSD 302) and returns/sends 355 a value to its credential field S2_C 361 in the UCL 310. The display queue 308 then retrieves/receives 365 value S2_C 361 from the UCL 310 and checks if the S2_C value equals 1 352. If it does equal 1, then E2 352 is displayed (on SSD 302) and returns/sends 375 a value to its credential field E2_C 362 in the UCL 310. If S2_C 361 value does not equal 1 352, then E2 is not displayed, and E2_C 362 value remains null, or some other default value.

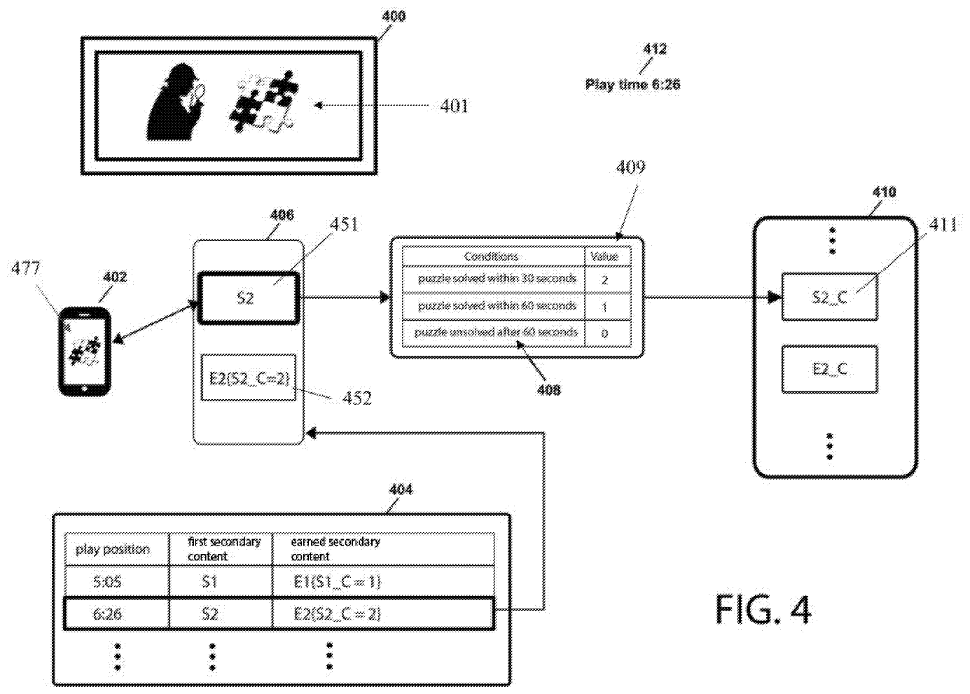

FIG. 4 is an illustration of one embodiment of the system showing the secondary screen device displaying first secondary content and returning a value to a user credential library based on which first secondary content's condition is met by the viewer. The primary display screen 400 currently displays a detective attempting to solve a puzzle 401. The SSD 402 receives a digital watermark from the PDS 400 and/or the media player of the PDS 400 and determines the current play time 412. The secondary content database 404 queues up first secondary content S2 451 and earned secondary content E2 452 in the display queue 406. The first secondary content S2 451 contains a puzzle 477 representative of the puzzle the detective is attempting to solve 401, the puzzle 477 displayed on the SSD 402 for interaction with the viewer. The viewer attempts to solve the puzzle 477 within a specified time limit, such as 30 or 60 seconds. The various conditions 408, along with their corresponding credential values 409, may be listed. After one of the conditions 408 is met, the corresponding value 409 is returned to the first secondary content S2's 451 credential field S2_C 411 in the UCL 410. As shown in the database 404, the earned secondary content E2 452 is only displayed if the user solves puzzle 477 within 30 seconds.

In some embodiments, the earned secondary content enhances the primary screen content for the viewer, meaning the viewer obtains a deeper understanding of an important facet of the primary screen content, such as additional plot details, character development, information or flashbacks revealing character motivation, anagnorisis, alternate endings, background on the characters, secret relationships between the characters, background on the scenes and/or locations, and/or different points of view of scenes shown on the PDS that offer additional information, such as (a) a conversation that is overheard unbeknownst to the characters having the conversation, (b) foreshadowing, and (c) plot twists. In some embodiments the earned secondary content may comprise of content that employs a priming technique that will help the viewer obtain anagnorisis content, such as a simulated text message that will prime to viewer to comprehend an otherwise distorted confession speech.

In some embodiments, the earned secondary content employs a priming technique that may help the viewer achieve the best possible condition of an interactive first or earned secondary content. One example of this may be an earned secondary content simulating earlier surveillance camera footage that recorded a villain's wedding ceremony in his secret hideout. The viewer is able to maneuver the camera, the direction of the camera, and, depending on at which angle the camera is aimed, the viewer may see various signs commemorating a specific date (such as Aug. 8, 2018). At a later time, the primary screen content may have the protagonist infiltrate that secret hideout to retrieve some documents from a safe. When the protagonist approaches the safe, she sees a photo from the wedding ceremony taped to it. Concurrently, the viewer may be presented with a first secondary content or earned secondary content representing the safe's keypad. A viewer who had been primed by the previous earned secondary content to think of the numbers 080818 may see the wedding ceremony photo taped to the safe, and associate the keypad combination with the ceremony date. Viewers without this “priming content” would either have to rely on alternative clues (if any) or blindly guess as to what the possible combination is if the combination is a puzzle to be solved by the person interacting with the secondary screen content.

In some embodiments the earned secondary content may contain content that is of a more restrictive MPAA rating than the MPAA rating of the primary screen content. For example, in a rated PG-13 romantic comedy there may be a scene where a guy and girl go on a date, and their conversation is within the guidelines of a PG-13 rating. Concurrently with the scene, the secondary screen device may present earned secondary content to the viewer representing the thoughts and images of one of the characters, which would be rated R.

In some embodiments, the first secondary content comprises of interactive “challenge” content that the viewer must correctly interact with to access certain earned content, thus setting up a structure of “challenge content”→“earned content” representative of a game. Such challenge contents should enhance the immersion of the movie and minimize overlap of the similar components of working memory with the concurrently displayed primary screen content (i.e., first secondary content may primarily engage the visuo-spatial sketchpad while the concurrently displayed primary screen content primarily engages the phonological loop) in order to reduce the likelihood of crossmodal attention interference and the overjustification effect. In some cases, the earned secondary content may also comprise of interactive “challenge” content as in the case where viewers must earn access to a certain challenge content.

In some embodiments, the interactive “challenge” content may be interactive content that contains no audible dialog (i.e. no audible speech or dialog between characters that may engage the phonological loop of the viewer or distract other viewers). It may further also be a visuospatial puzzle that is related to a movie content puzzle from the primary screen content i.e. the visuospatial puzzle is a puzzle that a character in the primary screen content attempts to solve, or the puzzle is seen or mentioned in the primary screen content. For example, one embodiment may be in a crime movie where the killer leaves a sliding tile puzzle for the detective to solve. While the detective is shown interacting with the puzzle on the primary display screen, the same puzzle may be presented to the viewer on the secondary screen device. Since presumably the viewer will interact with the puzzle, which primarily engages the visuospatial sketchpad component of the working memory, the concurrently displayed primary screen content ideally primarily engages the phonological loop component of the viewer. One embodiment of this may be by having the detective talk about the steps he's tried in solving the puzzle, or providing hints (i.e. “if I slid the green tile down, that will make room for the orange tile . . . ”). Viewers that correctly solve the puzzle may be presented with an earned secondary content that enhances the primary movie content; one possible embodiment of this is having the earned secondary content be anagnorisis content such as a video clip showing the killer, unbeknownst to the detective, is actually the detective's long-lost brother. Viewers with access to that video clip would have a better appreciation for the killer and his interactions with the detective on the primary display screen compared to viewers that don't have access. In some cases the visuospatial puzzle on the secondary screen device may be formatted to be user-friendly, such as being a smaller or truncated version of the puzzle from the primary screen content in order to fit on the secondary screen device display, and/or to allow for easier interaction by the viewer.

In some embodiments the interactive “challenge” content with no audible dialog may be a changeable point of view clip that comprises a clue that, if discovered by the viewer, enhances the primary movie content for that viewer. For example, consider a scene in the primary screen content where the protagonist is in a security room with surveillance cameras that monitor a gala party. An informant calls the protagonist to tell her a criminal is at the gala, and begins describing the criminal's features (i.e., height, hair color, complexion, and the like). As these details trickle in, which primarily engages the phonological loop, the secondary screen device may present content representing the point of view of a camera surveilling the gala. The viewer is able to maneuver the direction at which the camera is pointed/aimed (primarily engaging the visuospatial sketchpad). In this example, if the viewer spots the criminal, they may receive some anagnorisis content, such as seeing the criminal traveling with the protagonist's boss. Viewers who find this clue then know that the boss is a mole, and would have a better understanding for the boss's interactions with the protagonist on the primary display screen compared to viewers without that clue. Preferentially, the interactive changeable point of view clip may relate to the primary movie content, meaning it is an interactive video clip of a scene or a location seen in or mentioned in the primary screen content, in order to enhance the immersive experience.

In some embodiments, the interactive “challenge” content with no audible dialog may be a list of possible simulated actions in the primary screen content. For example, consider a crime movie in which a criminal kidnaps a child from preschool. The preschool is on a road that only runs in the east-west direction. The only witness to the kidnapping is a classmate, and when the detective asks the classmate what he remembers, the classmate draws a school bus. Being a child, the drawing is crude and the bus looks symmetrical from front to back, so it's not initially obvious which end is the front and which end is the rear of the bus. However, crucially, the drawing of the bus doesn't show any bus doors, so a keen observer may deduce that the bus is heading west. When this drawing is presented on the primary display screen, the secondary screen device may present the viewer with a list of simulated commands that the detective can issue to an off-camera police; the possible commands may be to travel west and look for clues, or travel east and look for clues. Viewers who correctly have the off-camera officer travel west may be rewarded with access to earned secondary content that enhances the primary screen content; one example of this may be a simulated report from the off-camera officer stating the child is safe, and was kidnapped because of a resemblance to the criminal's own younger brother. Viewers with this earned secondary content would thus have additional insight into the criminal's background and psyche compared to viewers without this earned secondary content. In another example, consider a scene in the primary screen content where an explorer is running out of a collapsing temple. Along the way, she passes by two identical-looking satchels. Concurrently, the secondary screen device may present the viewer with a list of actions: 1) take the left satchel; 2) take the right satchel. Regardless of which simulated action the viewer chooses, the primary screen content may resolve the choice by showing the explorer reach off screen to grab one of the satchels. The satchel may later reveal some treasure map on the primary display screen in order to advance the plot. However, viewers who chose to take the left satchel may additionally be rewarded with earned secondary content that enhances the primary movie content, such as an note from the satchel and presented on the secondary screen device stating that the explorer's father perished in that same temple years ago; viewers with that knowledge might have a newfound appreciation for any passion the explorer showed towards the temple on the primary display screen. In some embodiments, upon the presentation of a list of possible simulated actions in the primary screen content on the secondary screen device, the concurrently displayed primary screen content has N or greater seconds of no comprehendible dialog or speech, where N=floor[X] and X=the number of selections in the list of possible simulated actions. In these examples, the list of possible simulated actions in the primary screen content may present the illusion that the viewers are affecting the primary screen content (for example, by directing the actions of the protagonist) without actually changing the scenes or scene sequences on the primary display screen.

Preferably the first secondary content and earned secondary content are relevant and contextual to the primary screen content. This means that they involve characters, actions, events, or plots that are shown or mentioned in the primary screen content, and preferably do at least one of the following: 1) present an interactive challenge content to the viewer where the challenge itself is seen, mentioned, or implied to have occurred in the primary screen content; 2) enhance the primary screen content for the viewer. The first secondary content and the earned secondary content preferably are not advertisements, coupons, trivia, merchandise, summaries or explanations about (as opposed to being a part of) the movie, or content that is contextually irrelevant to the primary screen content.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such that the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method of displaying secondary content on secondary screen devices, comprising the steps:
providing a total movie content that comprises a primary screen content, a first secondary content, and an earned secondary content;
wherein said first secondary content and said earned secondary content are stored on a secondary content database and are relevant and contextual to said primary screen content;
wherein said primary screen content has a total play time;
wherein one or more instances of said first secondary content and one or more instances of said earned secondary content are each associated with a specific play time of said total play time of said primary screen content;
wherein each of said one or more instances of said earned secondary content has a required credential value that must be met in order for said one or more instances of said earned secondary content to be displayed on one or more secondary screen devices;
displaying on a primary display screen said primary screen content;
wherein said one or more secondary screen devices are synchronized to said total play time of said primary screen content being displayed on said primary display screen, such that said one or more secondary screen devices recognizes a current play time of said primary screen content;
wherein each of said one or more secondary screen devices is associated with a user credential library, and wherein each of said one or more instances of said first secondary content and each of said one or more instances of said earned secondary content has a field in said user credential library;
determining whether there are one or more of said one or more instances of said first secondary content that relate to said current play time of said primary screen content and, in the event that there are, displaying said one or more instances of said first secondary content on said one or more secondary screen devices;
wherein each of said one or more instances of said first secondary content comprises one or more first conditions and wherein each of said one or more first conditions is associated with a first value;
determining which of said one or more first conditions is met after displaying said one or more instances of said first secondary content;
sending said first value associated with said met first condition to said associated field in said user credential library;
determining whether there are one or more of said one or more instances of said earned secondary content that relate to said current play time of said primary screen content and, in the event that there is, determining whether each of said one or more secondary screen devices has said required credential value and, in the event that it does, displaying said one or more instances of said earned secondary content on said one or more secondary screen devices with said required credential value;
wherein each of said one or more instances of said earned secondary content comprises one or more earned conditions and wherein each of said one or more earned conditions is associated with an earned value;
determining which of said one or more earned conditions is met after displaying said one or more instances of said earned secondary content; and
sending said earned value associated with said met earned condition to said associated field in said user credential library.

2. The method of claim 1, wherein said first secondary content comprises an interactive content.

3. The method of claim 1, wherein said first secondary content comprises an interactive content that has no audible dialog.

4. The method of claim 1, wherein said first secondary content comprises an interactive visuospatial puzzle that is related to a movie content puzzle of said primary screen content.

5. The method of claim 1, wherein said first secondary content comprises an interactive and changeable point of view clip that comprises a clue that, if discovered, enhances said primary movie content for the discoverer.

6. The method of claim 1, wherein said first secondary content comprises an interactive list of possible actions that a character in said primary screen content might take.

7. The method of claim 1, wherein said first secondary content is displayed on said one or more secondary screen device at a time-offset of said current play time of said primary screen content.

8. The method of claim 1, wherein said earned secondary content comprises an interactive content.

9. The method of claim 1, wherein said earned secondary content comprises an interactive content that has no audible dialog.

10. The method of claim 1, wherein said earned secondary content comprises an interactive visuospatial puzzle that is related to a movie content puzzle of said primary screen content.

11. The method of claim 1, wherein said earned secondary content comprises an interactive and changeable point of view clip that comprises a clue that, if discovered enhances said primary movie content for the discoverer.

12. The method of claim 1, wherein said earned secondary content comprises an interactive list of possible actions that a character in said primary screen content might take.

13. The method of claim 1, wherein said earned secondary content is displayed on said one or more secondary screen device at a time-offset of said current play time of said primary screen content.

14. The method of claim 9, wherein said contextual, relevant, and audible dialog free earned secondary content comprises content with a more restrictive MPAA-rating than said primary screen content.

15. The method of claim 9, wherein said contextual, relevant, and audible dialog free earned secondary content comprises priming content.

16. The method of claim 9, wherein said contextual, relevant, and audible dialog free earned secondary content is selected from the group of content consisting of: a plot twist; foreshadowing content; anagnorisis content; and combinations thereof.

17. A method of displaying secondary content on secondary screen devices, comprising the steps:
providing a total movie content that comprises a primary screen content, a first secondary content, and an earned secondary content;
wherein said first secondary content and said earned secondary content are stored on a secondary content database;
wherein said primary screen content has a total play time;
wherein one or more instances of said first secondary content and one or more instances of said earned secondary content are each associated with a specific play time of said total play time of said primary screen content;
wherein each of said one or more instances of said earned secondary content has a required credential value that must be met in order for said one or more instances of said earned secondary content to be displayed on one or more secondary screen devices;
displaying on a primary display screen said primary screen content;
wherein said one or more secondary screen devices are synchronized to said total play time of said primary screen content being displayed on said primary display screen, such that said one or more secondary screen devices recognizes a current play time of said primary screen content;
wherein each of said one or more secondary screen devices is associated with a user credential library and wherein each of said one or more instances of said first secondary content and each of said one or more instances of said earned secondary content has a field in said user credential library;
determining whether there are one or more of said one or more instances of said first secondary content that relate to said current play time of said primary screen content and, in the event that there are, displaying said one or more instances of said first secondary content on said one or more secondary screen devices;
wherein each of said one or more instances of said first secondary content comprises one or more first conditions and wherein each of said one or more first conditions is associated with a first value;
determining which of said one or more first conditions is met after displaying said one or more instances of said first secondary content;
sending said first value associated with said met first condition to said associated field in said user credential library;
determining whether there are one or more of said one or more instances of said earned secondary content that relate to said current play time of said primary screen content and, in the event that there is, determining whether each of said one or more secondary screen devices has said required credential value and, in the event that it does, displaying said one or more instances of said earned secondary content on said one or more secondary screen devices that have said required credential value;
wherein each of said one or more instances of said earned secondary content comprises one or more earned conditions and wherein each of said one or more earned conditions is associated with an earned value;
determining which of said one or more earned conditions is met after displaying said one or more instances of said earned secondary content; and
sending said earned value associated with said met earned condition to said associated field in said user credential library;
wherein said first secondary content comprises an interactive content that is relevant and contextual to said primary screen content, and is one or more of the content selected from the group of interactive content consisting of: a visuospatial puzzle that is related to a primary content puzzle; a changeable point of view clip of a scene being shown on said primary screen content; a list of possible actions that a character in said primary screen content might take; and combinations thereof;
wherein said earned secondary content comprises an interactive content that is relevant and contextual to said primary screen content, and is one or more of the content selected from the group of interactive content consisting of: a visuospatial puzzle that is related to a primary content puzzle that is presented to a character in said primary screen content; a changeable point of view clip of a scene being shown on said primary screen content; a list of possible actions that a character in said primary screen content might take; content with a more restrictive MPAA-rating than said primary screen content; a plot twist; foreshadowing content; anagnorisis content; priming content; and combinations thereof.

18. A method of displaying secondary content on secondary screen devices, comprising the steps:
providing a venue that comprises a primary display screen, a plurality of user seats, and a media player;
providing one or more secondary screen devices;
wherein two or more users are seated in said plurality of user seats and wherein each of said two or more users has at least one of said one or more secondary screen devices;
providing a total movie content that comprises a primary screen content, a first secondary content, and an earned secondary content;
providing a user credential library;
associating said user credential library with said one or more secondary screen devices of said two or more users seated in said plurality of user seats; and
providing a secondary content database;
wherein said first secondary content and said earned secondary content are stored on said secondary content database;
wherein said primary screen content has a total play time;
wherein one or more instances of said first secondary content and one or more instances of said earned secondary content are each associated with a specific play time of said total play time of said primary screen content;
wherein each of said one or more instances of said earned secondary content has a required credential value that must be met in order for said one or more instances of said earned secondary content to be displayed on said one or more secondary screen devices;
displaying by said media player on said primary display screen said primary screen content;
synchronizing said one or more secondary screen devices to said total play time of said primary screen content being displayed on said primary display screen, such that said one or more secondary screen devices recognize a current play time of said primary screen content;
wherein each of said one or more instances of said first secondary content and each of said one or more instances of said earned secondary content has a field in said user credential library;
determining whether there are one or more of said one or more instances of said first secondary content that relate to said current play time of said primary screen content and, in the event that there are, displaying said one or more instances of said first secondary content on said one or more secondary screen devices of said two or more users seated in said plurality of user seats;
wherein each of said one or more instances of said first secondary content comprises one or more first conditions and wherein each of said one or more first conditions is associated with a first value;
determining which of said one or more first conditions is met after displaying said one or more instances of said first secondary content;
sending said first value associated with said met first condition to said associated field in said user credential library;
determining whether there are one or more of said one or more instances of said earned secondary content that relate to said current play time of said primary screen content and, in the event that there is, determining whether each of said one or more secondary screen devices has said required credential value and, in the event that it does, displaying said one or more instances of said earned secondary content on said one or more secondary screen devices that have said required credential value;
wherein each of said one or more instances of said earned secondary content comprises one or more earned conditions and wherein each of said one or more earned conditions is associated with an earned value;
determining which of said one or more earned conditions is met after displaying said one or more instances of said earned secondary content; and
sending said earned value associated with said met earned condition to said associated field in said user credential library.

19. The method of claim 18, wherein said earned secondary content comprises an interactive content that has no audible dialog, is relevant and contextual to said primary screen content, and is one or more of the content selected from the group of interactive content consisting of: a visuospatial puzzle that is related to a primary content puzzle that is presented to a character in said primary screen content; a changeable point of view clip of a scene being shown on said primary screen content; a list of possible actions that a character in said primary screen content might take; content with a more restrictive MPAA-rating than said primary screen content; a plot twist; foreshadowing content; anagnorisis content; priming content; and combinations thereof.

20. The method of claim 19, wherein said first secondary content comprises an interactive content that has no audible dialog and is one or more of the content selected from the group of interactive content consisting of: a visuospatial puzzle that is related to a primary content puzzle that is presented to a character in said primary screen content; a changeable point of view clip of a scene being shown on said primary screen content; a list of possible actions that a character in said primary screen content might take; and combinations thereof.

21. The method of claim 20, wherein said earned secondary content is displayed on said one or more secondary screen device at a time-offset of said current play time of said primary screen content and wherein said first secondary content is displayed on said one or more secondary screen device at a time-offset of said current play time of said primary screen content.

22. A system for displaying secondary content on secondary screen devices, comprising:
a venue that comprises a primary display screen, a plurality of user seats, and a media player;
two secondary screen devices, a first secondary screen device and a second secondary screen device;
wherein two users are respectively associated with said two secondary screen devices, a first user and a second user;
wherein said two users are seated in two of said plurality of user seats;
a total movie content that comprises a primary screen content, a first secondary content, and an earned secondary content;
a secondary content database that comprises said first secondary content and said earned secondary content;
wherein said primary screen content has a total play time;
wherein one or more instances of said first secondary content and one or more instances of said earned secondary content are each associated with a specific play time of said total play time of said primary screen content;
wherein said media player displays on said primary display screen said primary screen content;
wherein said two secondary screen devices are synchronized to said total play time of said primary screen content being displayed on said primary display screen, such that said two secondary screen devices recognize a current play time of said primary screen content;
wherein it is determined whether there are one or more of said one or more instances of said first secondary content that relate to said current play time of said primary screen content and, in the event that there are, said two secondary screen devices display said related one or more instances of said first secondary content to said two users seated in said plurality of user seats;
wherein, based on an interaction by each of said two users with said related and displayed one or more instances of said first secondary screen content, said first user and said first secondary screen device earns access to at least one instance of said one or more instances of said earned secondary content and said second user and said second secondary screen device does not earn access to said at least one instance of said one or more instances of said earned secondary content;
wherein it is determined whether there are one or more of said one or more instances of said earned secondary content that relate to said current play time of said primary screen content and, in the event that there is, it is determined that said first user has earned access to said related instance of said earned secondary content and said second user has not earned access to said related instance of said earned secondary content, such that said related instance of said earned secondary content is only displayed to said first user on said first secondary screen device, such that said first user and said second user have a different movie going experience;

23. The system of claim 22, wherein said earned secondary content comprises an interactive content that has no audible dialog, is relevant and contextual to said primary screen content, and is one or more of the content selected from the group of interactive content consisting of: a visuospatial puzzle that is related to a primary content puzzle that is presented to a character in said primary screen content; a changeable point of view clip of a scene being shown on said primary screen content; a list of possible actions that a character in said primary screen content might take; content with a more restrictive MPAA-rating than said primary screen content; a plot twist; foreshadowing content; anagnorisis content; priming content; and combinations thereof.

24. The system of claim 23, wherein said first secondary content comprises an interactive content that has no audible dialog and is one or more of the content selected from the group of interactive content consisting of: a visuospatial puzzle that is related to a primary content puzzle that is presented to a character in said primary screen content; a changeable point of view clip of a scene being shown on said primary screen content; a list of possible actions that a character in said primary screen content might take; and combinations thereof.

25. The system of claim 24, wherein said earned secondary content is displayed on said two secondary screen devices at a time-offset of said current play time of said primary screen content and wherein said first secondary content is displayed on said two secondary screen devices at a time-offset of said current play time of said primary screen content.
